(19) United States
(12) Patent Application Publication
(10) Pub. No.: US 2007/0000630 A1
(43) Pub. Date: Jan. 4, 2007

(54) Crepe facilitating composition

(76) Inventors: Thord Hassler, Helsingborg (SE); Geoff Sheridan, Cheshire (GB); Horst Reuter, Bad Herrenalb (DE)

Correspondence Address: BIRCH STEWART KOLASCH & BIRCH, PO BOX 747, FALLS CHURCH, VA, 22040-0747, US

(21) Appl. No.: 10/555,892

(22) PCT Filed: May 4, 2004
(86) PCT No.: PCT/SE04/00674

§ 371 Date: Nov. 7, 2005

(30) Foreign Application Priority Data
May 7, 2003 (SE) 0301329.9

(51) Int. Cl. B31F 1/12; D21H 21/14; D21H 17/20

(52) U.S. Cl. 162/111; 162/179; 162/180; 162/172; 162/175; 162/164.3; 162/164.1; 162/164.6; 162/177; 162/168.3

(57) ABSTRACT

The invention relates to a crepe facilitating aqueous composition comprising at least one water-insoluble, non-surface active thermoplastic material having a softening or melting point within the range of from 40° C. to 100° C., and at least one water-soluble polymer, preferably a cationic water-soluble polymer. As the composition is comprised in a wet fibre web during creping thereof, a more uniform creping is obtained while the integrity of the web is preserved and dust formation is reduced, and a tissue product having improved properties is provided.

### TECHNICAL FIELD

The present invention relates to the production of tissue products, in particular the creping step in this production.

More specifically, the invention relates to a crepe facilitating composition, use thereof, a method for manufacturing a tissue product, and a tissue product obtainable by said method.

### TECHNICAL BACKGROUND

Soft tissue products, such as facial tissues, toilet tissues, and kitchen roll towels, are linked by the common process by which they are generally manufactured, that is a process called creping. Creping is a process for mechanically compacting tissue paper in the paper machine direction and results in an increase in basis weight (mass per unit area) and other changes of the physical properties of the paper. Tissue paper normally has a grammage of about or less than 25 g/m².

When a web has been formed from a furnish of fibres and optional additives and most of the water has been removed through pressing, and sometimes also pre-drying, the web is transferred to a hot rotating drying cylinder called a Yankee cylinder (or Yankee dryer). A Yankee cylinder is a large diameter drum which may be pressurized with steam to provide a hot cylinder surface. The at least partially wet web has a natural adhesion to the cylinder surface. However, this adhesion is often considered to be insufficient, in particular when the moisture content of the web is low. Therefore, the cylinder surface is usually treated with additives that are sprayed directly onto the cylinder surface. These additives, generally a combination of one or more adhesives and a release agent, firmly adhere the wet web to the cylinder surface. The heat removes the moisture from the web, and when the web has reached the desired dryness, it is removed from the Yankee cylinder using a so-called doctor blade, also called a knife, that forces the web to separate from the Yankee cylinder. The increased adhesion achieved by the added adhesives improves the heat transfer allowing a more efficient drying of the web and a better creping.

It shall be noted that the adhesives also, besides controlling the extent of creping, prevent wear of the cylinder surface, provide lubrication between the blade and the cylinder surface, and reduce chemical corrosion of the cylinder surface.

The adhesives may either be sprayed directly onto the Yankee cylinder surface or added to the furnish before web consolidation. However, the adhesives are most commonly sprayed onto the cylinder since less amount of adhesives is needed than if added to the furnish.

A wide variety of adhesives are known in the art. Some examples of commonly used adhesives include polyvinylalcohol; polyethylene oxide; polyamines, such as polyamine-epihalohydrin resins; polyamides, such as polyamide-epihalohydrin resins; polyaminoamides; and lignin sulfonate. A common combination of adhesives are the reaction product of diethylene triamine, adipic acid and epichlorohydrin combined with polyvinyl alcohol.

As disclosed above, the adhesive(s) is/are usually combined with one or more release agents, such as hydrocarbon oils or mineral oils, to aid in the release of the web from the cylinder surface and also lubricate and protect the blade from excessive wear.

The whole process of contacting the web with the drying cylinder, firmly adhering this to the cylinder surface using adhesives, drying the web and subsequently mechanically removing the web from the cylinder surface using a blade, is a process of less than one second. The dwell time, i.e. the time period that the web is adhered to the Yankee cylinder, is generally from about 300 to 1000 msec. The time of removing the web from the Yankee cylinder using the blade is generally less than one millisecond.

The purpose of the creping process is to give the tissue paper desirable textural characteristics, such as softness, strength and bulk (i.e. the inverse of the density). The creping process creates minute crests in the web at close proximity to each other, thus forming a tissue paper having a specific three-dimensional structure (referred to as creped surface structure).

It is desirable in order to provide a tissue product with high perceived softness to obtain a uniform creping profile. However, in reality the creping (crest formation) is rather random. The distance between adjacent crests and the height of the crests vary quite considerably.

The tactile impression known as (perceived) softness is provided by a combination of several physical properties. The most important property is generally considered to be the stiffness of the web from which the tissue paper is made. The stiffness should be as low as possible for obtaining a high softness. Stiffness, in turn, is usually considered to be directly dependent on the tensile strength of the web. Strength is the ability to maintain physical integrity.

Increased adhesion between the web and the cylinder surface during the creping process causes decreased tensile strength of the web and thus increased softness.

While the creping process is required to create the desirable creped surface structure and textural characteristics of the tissue paper, it also creates significant damage to the integrity of the web. The impact of the doctor blade on the web results in rupture of some of the fibre-to-fibre bonds within the web leading to separation of the fibres, and sometimes even partial rupture of individual fibres. This, in turn, leads to various kinds of web imperfections. The fibres and the fragments of the fibres create a dust. It shall be noted that dust formed during this process also may comprise other materials, such as filler particles, comprised in the web.

Dust generated in the creping process will have a negative impact on the entire handling of the tissue paper, including during use by the consumer. Dust separated from the web will have a tendency to deposit on surfaces. The paper machine as well as all equipment used in the conversion of the web into the final tissue product is thus subjected to deposition of air-borne dust, such as fibres and fibre fragments, which is a significant disadvantage in the production process. The dust also has a negative impact on health and fire safety.

Hence, in the production of tissue paper, paper quality, in particular creping, is balanced against formation of dust.

Besides increasing the adhesion between the web and the Yankee cylinder, several other means, such as mechanical changes, e.g. changing the angle of the blade, can be made to increase the creping effect, but all these means generally lead to a further disintegration of the integrity of the web, i.e. increased dust formation and reduced crepe uniformity.

From the above, it is evident that creping is an essential step in the production of tissue paper, and considerable time and effort has been spent optimising this step to achieve an acceptable balance of paper quality against dust formation. While dust can, and often is, removed with vacuum cleaning, there is no method to improve the uniformity of the web after the creping process.

Furthermore, it shall be noted that some additives that generally are used in the production of tissue may further increase the disintegration of the web during creping. An example of such generally used additives are softness promoting agents (softeners).

Softeners may either be added to the web before or during its formation, such as by addition to the pulp or to the wet web, or after the web is dried.

According to prior art, softeners added to the web before or during its formation are surface active compounds, generally quaternary ammonium salts (QAS).

Quaternary ammonium salts are preferred since they, due to their cationic sites, exhibit high fibre substansitivity (the fibres are generally anionic). However, they are also known to reduce the tensile strength of the web and to negatively impair the creping process.

U.S. Pat. No. 5,635,028 describes the addition of a crepe-facilitating composition comprising a bonding inhibitor (softener), a cationic starch and a carboxymethyl cellulose. Examples of suitable bonding inhibitors according to U.S. Pat. No. 5,635,028 are quaternary ammonium compounds, such as ditallow dimethyl ammonium cloride, ditallow dimethyl-ammonium methyl sulfate, and di(hydrogenated)tallow dimethyl ammonium chloride (Varisoft® 137). It may be noted that all of these bonding inhibitors are surface active.

Furthermore, U.S. Pat. No. 5,059,282 describes the addition of a softener in the form of a polysiloxane (i.e. a silicone) to a wet tissue web. It may be noted that polysiloxanes are non-thermoplastic compounds.

Softeners added to the web before or during its formation reduce the stiffness of the web. It is generally believed that the reason for the decrease in web integrity caused by the addition of softeners is their tendency to decrease the strength of fibre-to-fibre bonds. A web with reduced bonding strength is more sensitive to the high stress impact during the creping process and dust formation is increased. It would be desirable to be able to add more softening agents without increase in dust formation.

Examples of softeners added after the web is dried (post-treatment) are, according to prior art (e.g. U.S. Pat. No. 6,179,961), basic waxes, such as paraffin wax; oils, such as mineral oil and silicone oil; functional silicones; fatty acids; fatty alcohols and fatty esters.

Retention agents, such as cationic starch, added to the furnish before consolidation into a web may be used in the production of tissue paper to improve its strength. This, in turn, may lead to a reduction in dusting. However, even at high addition rates there is still a considerable dusting. Further, cationic starch is not known to improve the uniformity of the web.

There clearly is a need for an improved creping process providing a uniform creping and reducing the disintegration of the fibre structure and the above-mentioned negative consequences of this.

### SUMMARY OF THE INVENTION

An object of the present invention is to alleviate the above problems and drawbacks, and to provide a crepe facilitating composition that, when added to a furnish of fibres before consolidating it into a web, will reduce the disintegration of the web during the subsequent creping process, thus reducing dust formation, and producing a more uniformly creped tissue product.

According to a first aspect of the invention, this object is achieved with a crepe facilitating aqueous composition comprising at least one water-insoluble, non-surface active thermoplastic material having a softening or melting point within the range of from 40° C. to 100° C. and at least one water-soluble polymer, preferably a cationic water-soluble polymer.

A second aspect of the invention relates to the use of said crepe facilitating aqueous composition in the manufacturing of a tissue product.

A third aspect of the invention relates to a method for manufacturing a tissue product from a furnish of fibres, said method comprising:
adding said crepe facilitating aqueous composition comprising at least one water-insoluble, non-surface active thermoplastic material having a softening or melting point within the range of from 40° C. to 100° C. and at least one water-soluble polymer to a furnish of fibres,
consolidating the furnish into a web,
creping the web, and
forming a tissue product from the creped web.

An advantage of the method is that it allows the tissue producer to make further modifications to the manufacturing process resulting in other advantages while still preserving the integrity of the web. Such a modification may, for instance, be an increased addition of softeners to further increase the softness of the final tissue product.

A fourth aspect of the invention relates to a tissue product obtainable by said method.

Other features and advantages of the present invention will become apparent from the following description of the invention.

### BRIEF DESCRIPTION OF DRAWINGS

FIGS. 1a and 1b, respectively, show tissue papers produced without and with the addition of a composition according to the invention.

FIGS. 2a and 2b, respectively, show tissue papers produced without and with the addition of a composition according to the invention.

FIGS. 3a and 3b, respectively, show tissue papers produced without and with the addition of a composition according to the invention.

### DETAILED DESCRIPTION OF THE INVENTION

As used herein the term “thermoplastic” means a material that repeatedly is transferable to a liquid or semi-liquid state by heating, and to a form-stable, essentially elastic state by cooling, within a temperature range specific for the material.

As used herein the term “water-insoluble” means a material that is soluble in water to less than 1% at 25° C.

As used herein the term “non-surface active” means a material that in an 1% (w/w) aqueous solution thereof has a surface tension of less than 30 dyn/cm.

As used herein the term “water-soluble” means a material that is soluble in water to at least 1% at 25° C.

As used herein the term “non-cationic” means a material being non-ionic or more or less anionic.

It has been found that the addition of certain thermoplastic water-insoluble, non-surface active materials to a fibre furnish before consolidating it into a web, will increase the tolerance to high stress impact on the web during the creping process and lead to improvements in paper quality.

Since high water absorbency is a desirable property of tissue paper, it has generally been believed that hydrophobic additives, such as water-insoluble, non-surface active thermoplastic materials, should be avoided in tissue production, since such additives are known to decrease the water absorbency. Hitherto, there has been no known benefit from adding water-insoluble, non-surface-active thermoplastic materials in the production of tissue.

There are, according to the invention, certain preferred requirements on the physical properties of the water-insoluble, non-surface active thermoplastic material, how this material is formulated into a composition and how the composition is used to achieve the improvements of the invention.

Firstly, the water-insoluble, non-surface active thermoplastic material of the composition according to the invention should have a melting or softening point within the range of from 40° C. to 100° C., preferably above 45° C. and below 95° C. More preferably, the melting point or softening point is within the range of from 50° C. to 90° C.

Creping is generally performed at a temperature of about 90-100° C., which allows the thermoplastic material of the composition according to the invention to melt or soften.

The melting point, softening point and melting range of thermoplastic materials may be determined by Differential Scanning Calorimetry (DSC).

Secondly, the water-insoluble, non-surface active thermoplastic material of the composition according to the invention is preferably non-cationic.

The water-insoluble, non-surface active thermoplastic material of the composition according to the invention should preferably not contain any quaternary amine groups. Quaternary amine groups are hydrophilic moieties which are undesirable in the water-insoluble, non-surface active thermoplastic material of the composition according to the invention.

Various types of water-insoluble, non-surface active thermoplastic material may be used according to the invention as long as the melting or softening point criterion is met.

A water-insoluble, non-surface active thermoplastic material may either be used alone or in combination with one or more other water-insoluble, non-surface active thermoplastic materials.

Examples of suitable water-insoluble, non-surface active thermoplastic materials include waxes; fatty alcohols (i.e. acyclic alcohols derived from natural fatty acids or prepared from synthetic starting materials), such as a mixture of C14, C16 and C18 fatty alcohols or a mixture of C16, C18 and C20 fatty alcohols, and some esters thereof (under proviso that they are non-surface active and thermoplastic); fatty acids (monocarboxylic acids) and some esters thereof (under proviso that they are non-surface active and thermoplastic), such as stearic acid, and some esters thereof, and some kinds of waxes (some waxes comprise esters of fatty acid and alcohol); and rosin acids or esters thereof, either as gum rosin or produced by distillation of the tall oil produced in the Kraft pulping process.

Said fatty alcohols, fatty acids or esters thereof should preferably have a chain length of more than 12 carbon atoms (C12).

Examples of preferred waxes are montan waxes, paraffin waxes, oxidized paraffin waxes, polyethylene waxes, microcrystalline waxes, Carnauba wax, and synthetic waxes produced by the Ficher-Trops process.

When a mixture of two or more water-insoluble, non-surface active thermoplastic materials is used it is essential that the mixture, rather than each individual component, has a melting point or softening point within the above specified range. As an example a polyethylene wax having a melting point above 100° C. can be mixed with a paraffin wax to give a mixture with a softening point within the specified range.

For certain mixtures the melting range, measured with DSC, may be quite broad. It is not essential that the mixture of water-insoluble, non-surface active thermoplastic material is completely molten below 100° C. even if the web during the creping process normally never exceeds this temperature. It is sufficient that the thermoplastic material, or the mixture of thermoplastic materials, softens below 100° C.

Thirdly, the water-insoluble, non-surface active thermoplastic material should be brought into contact with the fibres of the furnish, i.e. there should be an affinity between the thermoplastic material and the (anionic) cellulose fibres. This is achieved by preparing an aqueous composition of the water-insoluble, non-surface active thermoplastic material and a water-soluble polymer.

The water-insoluble, non-surface active thermoplastic material is preferably dispersed in an aqueous solution of the water-soluble polymer.

The choice of suitable water-soluble polymer depends on the wet end chemistry, more particularly the system charge.

The system charge can conveniently be determined using colloid titration. The process water is then titrated with a charged polymer to the isoelectric point. In most systems, the charge is anionic since the fibres naturally exhibit an anionic charge. However, in certain systems, particularly when large quantities of cationic additives are used, such as wet strength agents, the system charge may be found to be close to neutral or even cationic.

As a general rule, when the system charge is found to be substantially anionic, a composition according to the invention comprising a cationic water-soluble polymer should be used.

When the system charge is found to be close to neutral or substantially cationic (which is rarely the case), a composition according to the invention comprising a non-ionic or anionic water-soluble polymer, respectively, should be used.

Thus generally speaking, the water-soluble polymer (or more specifically the charge thereof) in the composition according to the invention is selected so that the overall charge of the system is not affected.

In most cases, a composition according to the invention comprising at least one cationic water-soluble polymer is preferred.

Various cationic water-soluble polymers can be used, both organic and inorganic. Cationic starch; polyDADMAC (polydimethyldiallyl ammonium chloride); polyaluminium chloride; polyamine-epichlorohydrin resins, such as reaction products of epichlorohydrin and dimethyl amine; and cationic polyamides, such as resins made from condensing dicyandiamide with formaldehyde, are preferred. Mixtures of one or more water-soluble cationic polymers can also be used.

Said at least one cationic water-soluble polymer may optionally be combined with at least one cationic surfactant.

Quaternary fatty amines is an example of a class of useful cationic surfactants.

Examples of suitable anionic water-soluble polymers for use in the composition according to the invention are carboxymethyl cellulose (CMC) and anionic polyacrylamides.

An example of a suitable non-ionic water-soluble polymer for use in the composition according to the invention is amphoteric starch, i.e. starch with both anionic and cationic moieties balanced to equal charge.

The water-soluble polymer in the composition according to the invention preferably has an average molecular weight of at least 50 000.

In principle, there is no upper limit for the ratio of water-soluble polymer to water-insoluble, non-surface active thermoplastic material. However, no additional benefit is achieved using a weight ratio above 1:1, and thus, in view of cost efficiency, a ratio below 1:1 is preferred.

The ratio should preferably be within the range of from 0.01 to 1 parts of weight water-soluble polymer to 1 parts of weight water-insoluble, non-surface active thermoplastic material, more preferably within the range of from 0.05 to 0.25 parts of weight water-soluble polymer to 1 parts of weight water-insoluble, non-surface active thermoplastic material.

The water-soluble polymer may either be added before the preparation of the dispersion of water-insoluble thermoplastic material or after the dispersion has been prepared.

The charge of a dispersion can be determined by several different methods. Charge titration with an anionic polymer (Mutec titration) and determination of the electrophoretic mobility (Zeta-potential) are two common methods for measuring the charge. The charge of an anionic dispersion is determined by titration with a cationic polymer, and visa versa.

Fourthly, it is preferred that the average particle size of the water-insoluble, non-surface active thermoplastic material is small, such as equal to or less than 5 μm, in particular equal to or less than 1.5 μm.

Furthermore, the average particle size should preferably be equal to or larger than 0.2 μn.

The particle size can be determined by a number of different methods, such as by measurement with a Malvern particle size analyser.

In order to achieve the right particle size and stability of the aqueous composition comprising the dispersed water-insoluble, non-surface active thermoplastic material and the dissolved water-soluble polymer, also other additives may be used. Such additives include surfactants, anionic or non-ionic polymers, preservatives to prevent microbiological degradation and improve the shelf life, and acids or bases to adjust pH of the composition. As within the knowledge of persons skilled in the art, each specific composition may be carefully balanced to provide the desired particle size and stability.

The composition according to the invention is preferably made by dispersing the water-insoluble, non-surface active thermoplastic material, or a mixture of two or more water-insoluble, non-surface active thermoplastic materials, in water at a temperature above the melting or softening point of the material, preferably in the presence of a surfactant to reduce the particle size and to provide stability of the dispersion.

As known to persons skilled in the art, various dispersing methods may be used to obtain the desired dispersion. High shear mixing or homogenisation is preferred to produce the dispersion of said water-insoluble, non-surface active thermoplastic material in water.

The water-soluble polymer may be added either before or after the dispersion has been prepared.

The crepe facilitating composition according to the invention should be added to the furnish of fibres before said furnish is consolidated into a wet web.

It is also important that the water-insoluble, non-surface active thermoplastic material of the composition is allowed to evenly distribute in the furnish.

As long as these two requirements are met, it is less important where in the manufacturing process the addition of the composition occurs. In practice, addition of the composition to the machine chest is convenient. Also later addition may be suitable, such as addition just before the fan pump. The crepe facilitating composition according to the invention may also be added after the fan pump, but in that case there is a risk that the water-insoluble, non-surface active thermoplastic material will not be evenly distributed in the furnish and consequently not attached to the fibres before the furnish is consolidated into a web. However, if uniform distribution and retention of the thermoplastic material are achieved, later addition is also possible.

The method according to the invention also allows the tissue producer to introduce, remove, decrease or increase the addition of other additives and make mechanical changes that will improve the manufacturing process while still preserving the integrity of the web.

An example is increased addition of softeners to increase the tissue softness while still preserving the integrity of the web and decreasing the dust formation.

The method according to the invention also allows for a reduction in softener addition since an increase of the web uniformity per se will increase the perceived softness.

The present invention can be used together with essentially all other additives generally used in tissue production. Such additives include, for instance, wet strength agents, dry strength agents, softeners, dyes as well as additives intended to improve the process without affecting the tissue properties, such as retention and drainage agents, defoamers, slime controlling agents, pitch controlling agents, and agents that decrease the deposition of material from recycled paper.

For example, it may be desirable to separately add a retention agent to improve the retention of the water-insoluble thermoplastic material. Suitable retention agents are highly cationic water-soluble polymers, such as polyDADMAC and condensation polymers of epichlorohydrin and dimethyl amine, and resins of diethylene triamine, adipic acid and epichlorohydrin. Also polyacryl amides, cationic starch and other conventional retention agents can be used. It shall be noted that in the case where a retention agent is separately added, the amount of the retention agent is in addition to the water-soluble polymer comprised in the crepe facilitating composition. In the case when the charge of the system is close to neutral it may be advantageous to use an anionic polymer to reduce the charge since it generally is considered unfavourable to operate a paper machine around the isoelectric point.

The present invention can be used together with any fibre composition generally used to produce tissue paper. Since recycled cellulose fibres generally are weaker than virgin cellulose fibres, the advantages with the invention may be more significant when the tissue is made from recycled cellulose fibres.

Furthermore, the present invention is useful together with all known adhesives and combinations of adhesives and release agents that are used for improving the adhesion between the web and the Yankee cylinder. As disclosed in the introduction, the adhesive may either be sprayed onto the surface of the cylinder or added to the furnish before consolidation to a web. The present invention is useful in both these applications.

To achieve the desired effect of the present invention while preserving a satisfactory water absorbency, it is preferred that the addition rate of the crepe facilitating composition comprising the water-insoluble, non-surface active thermoplastic material to the furnish of fibres is kept low. The addition rate of the thermoplastic material may vary between different embodiments, and will depend on a variety of parameters, such as the type of thermoplastic material used, how the material is dispersed, tissue paper machine design and the desired effect sought.

An addition rate of maximum 1% of dry water-insoluble, non-surface active thermoplastic material based on the dry weight of the web is preferred and will give the desired effect according to the invention without negatively affecting the water absorbency of the tissue product. The positive effect of the invention will also be achieved at addition rates above 1%, but such an increased addition rate will not give any additional improvement, and there may be a risk that the water absorbency of the tissue product will be negatively affected. This can easily be determined by testing the rate of absorbency of the tissue paper.

The lowest addition rate of dry water-insoluble, non-surface active thermoplastic material according to the invention is preferably 0.03% dry water-insoluble thermoplastic material based on the dry weight of the web.

The appropriate addition rate is determined by testing on the tissue paper machine, but will in most applications be found to preferably be within the range of from 0.1% to 0.6% of dry water-insoluble, non-surface active thermoplastic material based on the dry weight of the web.

Without being bound by any theory or limiting the scope of the invention, it is believed that the water-insoluble, non-surface active thermoplastic material improve the distribution of the stress affecting the web when this is cut from the Yankee cylinder. Spreading the stress over a larger area is believed to circumvent the extraordinary stress that otherwise will impact some areas of the web leading to fibre separation or fibre rupture. The increased distribution of the stress over a larger area will also create a more uniformly creped tissue, and thus a tissue product having improved properties. The crest height and the distance between adjacent crests in the tissue paper will be more uniform. It is believed that this is the result from lubrication of the bonding between individual fibres giving the web a better flexibility during the creping.

The method according to the invention is suitable for all processes of tissue production. In some processes the web is pre-dried by passing the web over a stream of hot air before creping. This method is referred by those skilled in the art as through-air-drying. In another embodiment of the process, the web is partially creped on a first Yankee cylinder and then transferred to a second Yankee cylinder and creped a second time. In yet another embodiment of the process the web is also subjected to IR (infrared) drying or drying with direct flames of burning gas to remove water. The invention is suitable for all known process variations of tissue manufacturing as long as the web is adhered to a drying cylinder and then removed from the cylinder using a blade.

The invention will now be illustrated by means of the following non-limiting examples.

### EXAMPLE 1

A dispersion with a dry content of 38% (w/w) of a paraffin wax (water-insoluble, non-surface active thermoplastic material) with a melting point of 55° C. prepared in the presence of cationic starch (water-soluble polymer) to make the paraffin wax particles (average particle size about 1 μm) self-retaining to anionic cellulose fibres, was added at a rate of 2.5 kg/ton (approximately 0.25%) to a machine chest containing a furnish of a mixture of softwood kraft and de-inked fibres. The ratio by weight of paraffin wax to cationic starch was 30:1.

The furnish was dewatered over a papermaking wire, pressed to a dryness of approximately 42%, and passed to a Yankee cylinder coated with an adhesive of a fully cross-linked polyamidoamine resin.

The uniformly creped web was removed from the Yankee cylinder using a blade, rolled up into a tissue roll, rewinded from the roll and formed into a final tissue product.

The dusting during these operations was compared with and without addition of the composition comprising the wax dispersion and the cationic starch, and was found to be significantly reduced when the paraffin wax composition was applied.

### EXAMPLE 2

A hot melt mixture comprising a thermoplastic paraffin wax and a thermoplastic rosin acid made by distillation of tall oil from Kraft pulping, said mixture having a softening point of 86° C., was dispersed in water in the presence of polyDADMAC (water-soluble polymer). The ratio by weight of paraffin wax and rosin acid to polyDADMAC was 25:1.

A Malvern particle size analyser was used to determine the average particle size of the particles of the thermoplastic mixture, and the average particle size was found to be about 1 μm.

The composition of wax, rosin acid and polyDADMAC was added at a rate of 1.8 kg/ton (approximately 0.2%) on dry weight basis to a machine chest containing a furnish of softwood kraft.

The tissue machine was producing toilet tissue at a rate of 5.5 ton/h.

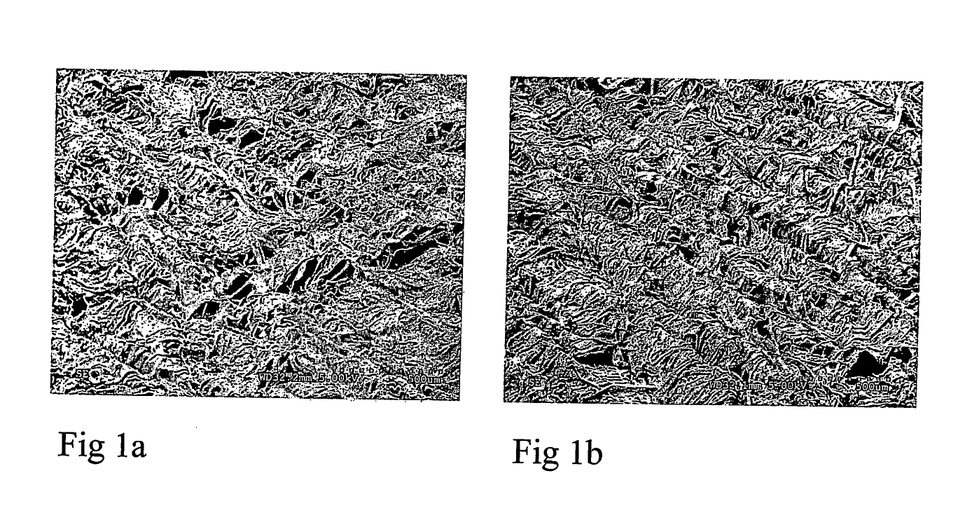

The crepe uniformity of the web after creping was determined by microphotographs of tissues produced with and without addition of the composition containing wax, rosin acid and polyDADMAC. The photographs (FIG. 1) show a considerable improvement in creping uniformity of the tissue paper. FIG. 1a and FIG. 1b, respectively, show the tissue paper produced without and with addition of said composition.

A second advantage was that the dusting of the tissue paper in manufacturing procedures, such as the rewinding and converting of the tissue paper to the final tissue product, was found to be considerably reduced.

### EXAMPLE 3

The dispersion of Example 2 was added at a rate of 4 kg/ton to a machine chest containing a furnish of virgin fibres.

The furnish was dewatered over a papermaking wire, pressed, and dried on a Yankee cylinder.

The uniformly creped web was removed from the Yankee cylinder using a blade, rolled up into a tissue roll, rewinded from the roll and formed into a final tissue product.

The tissue machine was producing toilet tissue (20 g/m²) at a speed of 1500 m/min.

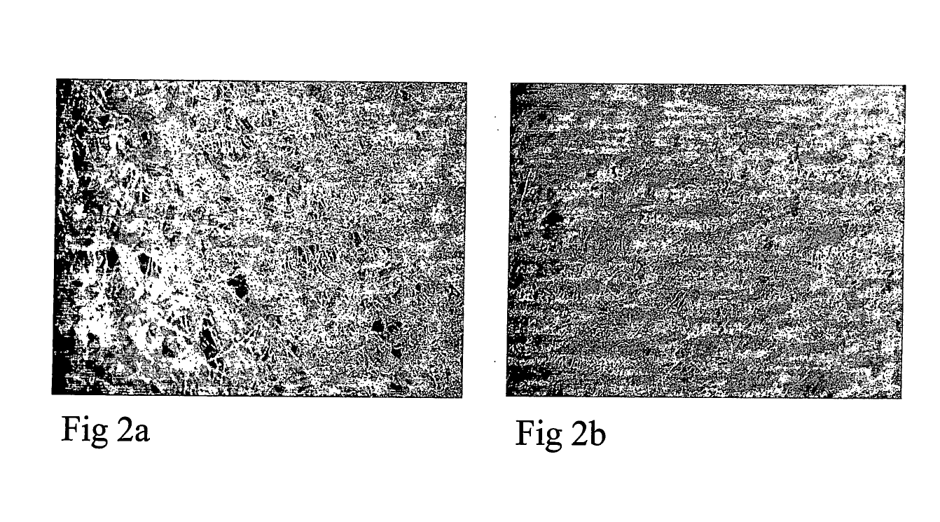

The crepe uniformity of the web after creping was determined by microphotographs of tissues produced with and without addition of the composition of Example 2. The photographs (FIG. 2) show a considerable improvement in creping uniformity, and thus an increased softness perception, of the tissue paper. FIG. 2a and FIG. 2b, respectively, show the tissue paper produced without and with addition the composition of Example 2.

Other advantages were reduced dusting, improved machine and converting runnability (i.e. less unscheduled downtime for cleaning), longer blade life, and improved fibre retention.

### EXAMPLE 4

Example 3 was repeated except that the composition was added at a rate of 5 kg/ton and that the tissue machine was producing towelling paper (20 g/m²) at a speed of 1900 m/min.

The dust levels were measured on the front and back of the tissue sheet upon leaving the Yankee dryer using an airborne particle monitor.

These dust levels were compared with dust levels measured for towelling manufacturing without addition of the composition.

The dusting was found to be reduced by more than 30% by adding the composition of Example 2.

Furthermore, the creping profile of the produced tissue was found to be more uniform, thus providing an increased softness perception of the towelling.

Other advantages were improved converting runnability and improved printability.

### EXAMPLE 5

Example 3 was repeated except that the composition was added at a rate of 1 kg/ton to a furnish of de-inked pulp (DIP) fibres and that the tissue machine was producing toilet tissue (18 g/m²) at a speed of 1600 m/min.

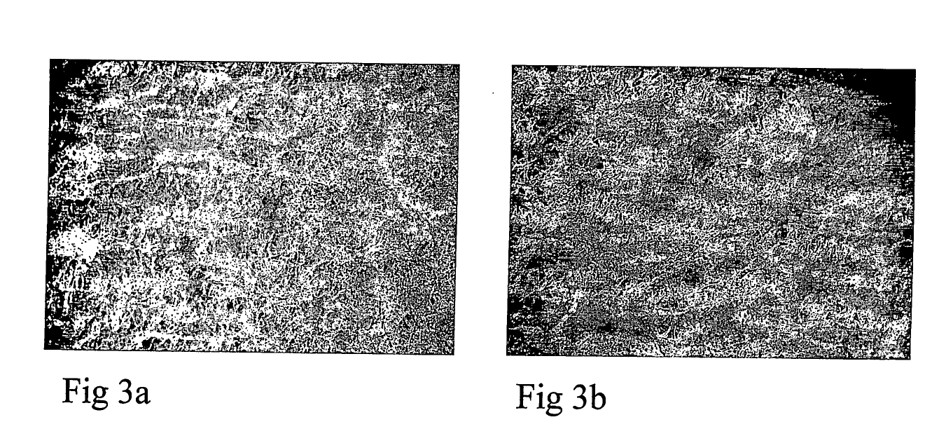

The crepe uniformity of the web after creping was determined by microphotographs of tissues produced with and without addition of the composition. The photographs (FIG. 3) show a considerable improvement in creping uniformity, and thus an increased softness perception, of the tissue paper. FIG. 3a and FIG. 3b, respectively, show the tissue paper produced without and with addition of the composition.

Other advantages were reduced dusting and improved converting runnability.

### EXAMPLE 6

Example 3 was repeated except that the composition was added at a rate of 2.5 kg/ton to a furnish of 75% virgin fibres and 25% DIP fibres, and that the tissue machine was producing napkins (25 g/m²) at a speed of 1200 m/min.

The dust levels were measured on the front and back of the tissue sheet upon leaving the Yankee dryer using an airborne particle monitor.

These dust levels were compared with dust levels measured for napkin manufacturing without addition of the composition of Example 2.

The dusting was found to be reduced by more than 50% by adding the composition of Example 2.

Furthermore, the creping profile of the produced tissue was found to be more uniform, thus providing an increased softness perception of the napkin.

Other advantages were improved converting runnability and improved printability.

While the invention has been described in detail and with reference to specific embodiments thereof, it will be apparent for one skilled in the art that various changes and modifications can be made therein without departing from the spirit and scope thereof.

1. A crepe facilitating aqueous composition for use in the manufacturing of a tissue product characterized in comprising at least one water-insoluble, non-surface active thermoplastic material having a softening or melting point within the range of from 40° C. to 100° C., and at least one cationic water-soluble material water-soluble polymer.

2. A composition according to claim 1, wherein the softening or melting point is within the range of from 50° C. to 90° C.

3. A composition according to claim 1, wherein the water-insoluble, non-surface active thermoplastic material is non-cationic.

4. A composition according to claim 1, wherein the water-insoluble thermoplastic material is selected from the group consisting of waxes; fatty alcohols and esters thereof; fatty acids or and esters thereof, and rosin acids or esters thereof.

5. A composition according to claim 4, wherein the water-insoluble thermoplastic material is selected from the group consisting of montan waxes; paraffin waxes; oxidized paraffin waxes; polyethylene waxes; microcrystalline waxes; Carnauba wax; and synthetic waxes produced by the Ficher-Trops process.

6. A composition according to claim 1, wherein the water-insoluble thermoplastic material has an average particle size equal to or less than 5 μm.

7. A composition according to claim 6, wherein the water-insoluble thermoplastic material has an average particle size equal to or less than 1.5 μm.

8. A composition according to claim 1, wherein said at least one water-soluble polymer is a cationic water-soluble polymer.

9. A composition according to claim 8, wherein the cationic water-soluble material is a said at least one water-soluble cationic polymer is selected from the group consisting of cationic starch; polydimethyldiallyl ammonium chloride (polyDADMAC); polyaluminium chloride; cationic polyamides; and polyamine-epichlorohydrin resins.

10. A composition according to claim 1, wherein said at least one water-soluble polymer is used in combination with at least one cationic surfactant.

11. A composition according to claim 10, wherein said at least one cationic surfactant is a quaternary fatty amine.

12. A composition according to claim 1, wherein said at least one water-soluble polymer is an anionic water-soluble polymer.

13. A composition according to claim 12, wherein said at least one anionic water-soluble polymer is selected from the group consisting of carboxymethyl cellulose and polyacrylamide.

14. A composition according to claim 1, wherein said at least one water-soluble polymer is a non-ionic water-soluble polymer.

15. A composition according to claim 14, wherein said at least one non-ionic water-soluble polymer is amphoteric starch.

16. Use of a crepe facilitating aqueous composition according to claim 1 in the manufacturing of a tissue product.

17. A method for manufacturing a tissue product from a furnish of fibres, characterized in comprising
adding an crepe facilitating aqueous composition according to claim 1 to a furnish of fibres,
consolidating the furnish into a web,
creping the web, and
forming a tissue product from the creped web.

18. A method according to claim 17, wherein the aqueous composition is added to the furnish at an addition rate within the range of from 0.03 to 1% (w/w) dry water-insoluble, non-surface active thermoplastic material based on dry weight of the web.

19. A method according to claim 18, wherein the addition rate is within the range of from 0.1 to 0.6% (w/w) dry water-insoluble, non-surface active thermoplastic material based on dry weight of the web.

20. A tissue product obtainable by the method according to claim 17.
